(19) United States
(12) Patent Application Publication
(10) Pub. No.: US 2020/0287194 A1
(43) Pub. Date: Sep. 10, 2020

(54) ELECTRICAL CONNECTING MEMBER HOUSING CASE AND BATTERY MODULE

(71) Applicant: HITACHI AUTOMOTIVE SYSTEMS, LTD., Ibaraki (JP)

(72) Inventors: Kazuaki URANO, Hitachinaka-shi (JP); Sadayuki AOKI, Hitachinaka-shi (JP); Kazunori OJIMA, Hitachinaka-shi (JP); Takashi SUZUKI, Hitachinaka-shi (JP)

(21) Appl. No.: 16/648,782

(22) PCT Filed: Aug. 3, 2018
(86) PCT No.: PCT/JP2018/029174

§ 371 Date: Mar. 19, 2020

(30) Foreign Application Priority Data
Sep. 29, 2017 (JP) 2017-189410

(51) Int. Cl. H01M 2/20; H01M 2/10; H01M 2/30; H01R 25/14

(52) U.S. Cl. CPC H01M 2/206; H01M 2/1077; H01M 2220/20; H01R 25/14; H01M 2/305

(57) ABSTRACT

Provided is a battery module capable of efficiently arranging wires such as voltage detection wires and temperature detection wires, and realizing the miniaturization thereof. The electrical connecting member housing case of the present invention includes a wire housing space formed from a bottom part, a wall part, and a lid part, wherewith the wall part includes an outer wall, an end face, and an inner wall facing the wires, and wherein the lid part is connected to the wall part via a hinge part provided to the inner wall or the end face.

### TECHNICAL FIELD

The present invention relates to an electrical connecting member housing case, and to a battery module comprising such an electrical connecting member housing case.

### BACKGROUND ART

A battery module is provided with a plurality of wires for detecting the voltage and temperature of the secondary battery, and these wires are bundled and housed in an electrical connecting part housing case (bus bar case) provided to the secondary battery.

As a structure of the wire housing space for housing the bundled wires, for instance, PTL 1 describes a wire housing frame characterized in that a locking protrusion is provided to an upper end outer side wall on the front side of the wire housing frame, an openable/closable lid is connected to a side wall on the back side of the frame via a hinge, a locking protrusion is provided to a lower end inner face of the lid end side wall which is bent downward from the end of the lid, and the front side wall locking protrusion is locked with a rib protruding toward the lower face of the lid.

Nevertheless, in a battery system for use in electrically driven vehicles in recent years, more battery cells are being used pursuant to cost reduction and miniaturization, and demanded is the further miniaturization of a battery system capable of more efficiently housing the wires. In light of the foregoing background, a more efficient wire housing structure is demanded.

### CITATION LIST

### Patent Literature

PTL 1: Japanese Utility Model Registration No. 2583435

### SUMMARY OF THE INVENTION

### Problems to be Solved by the Invention

Conventionally, a wire housing space for housing the bundled wires was provided, for example, along the laminating direction of the secondary battery of the bus bar case, and, in certain cases, was provided by being separated into multiple rows. A bus bar case needs to be designed to be compact on the whole by giving consideration to the arrangement of the bus bar, terminal, and external terminal of the secondary battery module in addition to the wire housing space.

Nevertheless, with PTL 1, because the hinge is provided on the outer side of the wall forming the wire housing space, space for providing the lid and hinge is required, and there is a possibility that an efficient design may be difficult.

An object of the present invention is to provide an electrical connecting member housing case of a battery module capable of efficiently arranging wires such as voltage detection wires and temperature detection wires and realizing the miniaturization thereof by reducing, as much as possible, space for providing the lid and hinge around the wire housing space in the bus bar case.

### Means to Solve the Problems

An electrical connecting member housing case including a wire housing space formed from a bottom part, a wall part, and a lid part, wherewith the wall part includes an outer wall, an end face, and an inner wall facing the wires, and wherein the lid part is connected to the wall part via a hinge part provided to the inner wall or the end face.

### Advantageous Effects of the Invention

Because the present invention does not require space for providing the lid or hinge around the wire housing space, the present invention can provide an electrical connecting member housing case of a battery module capable of realizing the miniaturization thereof.

### BRIEF DESCRIPTION OF DRAWINGS

FIG. 1 is an external perspective view of the battery module according to Embodiment 1 of the present invention.

FIG. 2 is an exploded perspective view of the battery module shown in FIG. 1.

FIG. 3 is an external perspective view of the battery block shown in FIG. 2.

FIG. 4 is an external perspective view of the battery cell shown in FIG. 3.

FIG. 5 is a plan view in which a part of the top cover of the battery module shown in FIG. 1 has been removed.

FIG. 6 is an exploded perspective view of the electrical connecting member housing case of the battery module 100 shown in FIG. 5, and is a diagram showing a state where the lid part of the wire housing space groove 80 is opened.

FIG. 7 is an exploded perspective view showing a state where the lid of the battery module wire housing space shown in FIG. 5 is closed.

FIG. 8 is a cross sectional view in which a part of the cover of the battery module according to Embodiment 1 of the present invention has been removed.

FIG. 9 is a conceptual cross sectional view of the wire housing space according to conventional technology.

FIG. 10 is a conceptual cross sectional view of the wire housing space according to Embodiment 1 of the present invention.

FIG. 11 is a perspective view of FIG. 10.

FIG. 12 is a conceptual cross sectional view of the wire housing space according to a second embodiment of the present invention.

FIG. 13 is a conceptual cross sectional view of the wire housing space according to a third embodiment of the present invention.

FIG. 14 is a perspective view of FIG. 13.

FIG. 15 is a conceptual cross sectional view of the wire housing space according to a fourth embodiment of the present invention.

FIG. 16 is a separate example of the fourth embodiment.

### DESCRIPTION OF EMBODIMENTS

An embodiment of the battery module according to the present invention is now explained with reference to the appended drawings.

### First Embodiment

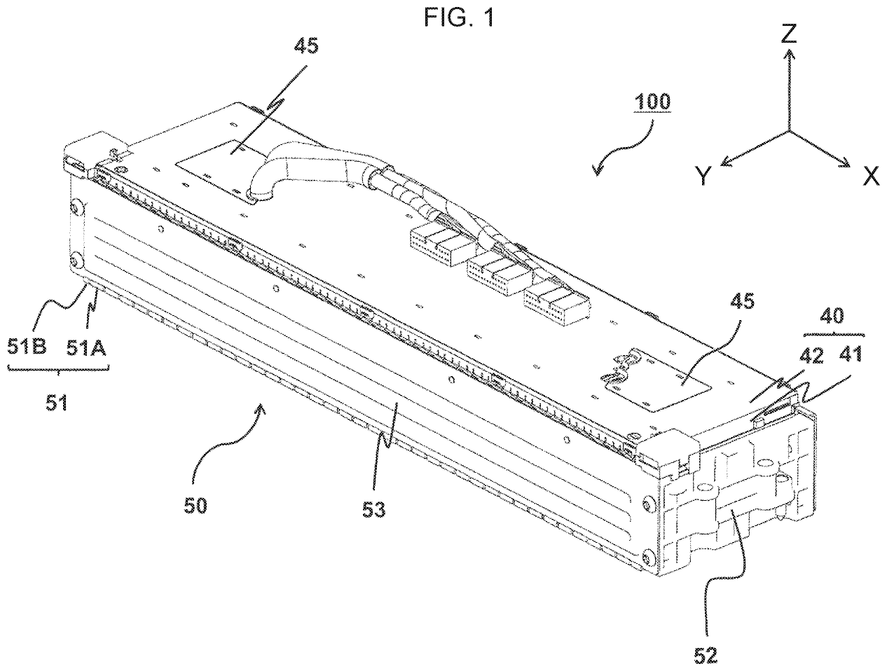

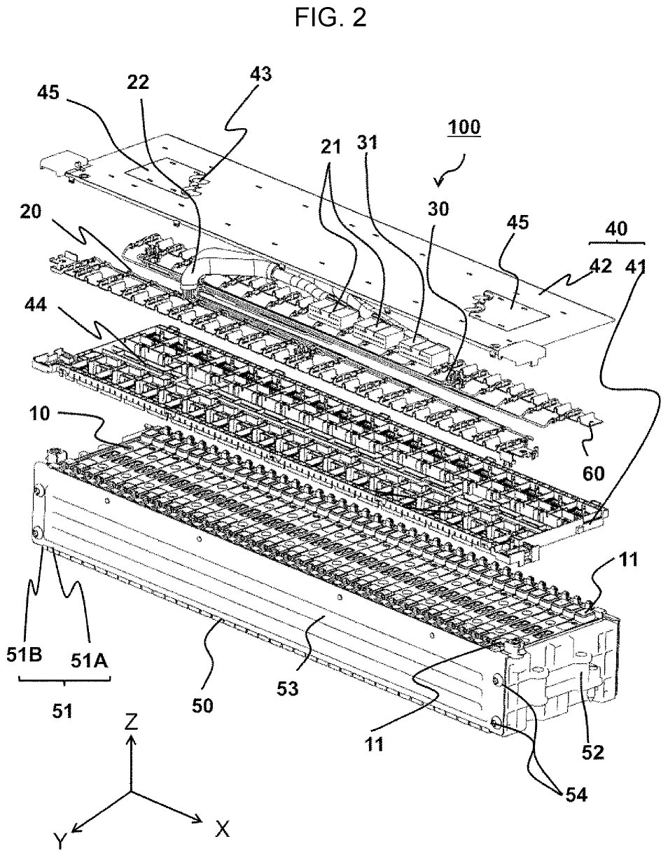

FIG. 1 is an external perspective view of a battery module 100 according to Embodiment 1 of the present invention. FIG. 2 is an exploded perspective view of the battery module 100 shown in FIG. 1.

The battery module 100 comprises a plurality of battery cells 10, a plurality of voltage detection wires 20 connected to an external terminal 11 of each of the battery cells 10, and a plurality of temperature detection wires 30 connected to the plurality of battery cells 10. The plurality of battery cells have a flat shape, and are laminated by causing the broad-side faces to face each other. The battery module 100, as shown in FIG. 1, comprises an electrical connecting part housing case 40 which covers a top face 10a of the plurality of battery cells 10. Electric wires can be efficiently arranged by providing the electrical connecting part housing case 40 on the terminal side of the laminated secondary batteries.

As shown in FIG. 1 and FIG. 2, the electrical connecting part housing case 40 includes, for example, an insulation cover 41 which is disposed to face the top face 10a of the plurality of battery cells 10 configuring a battery block 50, and a top cover 42 which covers the upper part of the insulation cover 41. The insulation cover 41 is provided with holes, and the external terminals 11 are inserted into these holes and connected to the bus bars provided to the insulation cover 41.

The insulation cover 41 is prepared, for instance, from a resin material having insulation properties such as general-purpose resin (polypropylene or the like) or engineering plastic, and is a thin plate-shaped member which covers at least a part of the top face 10a of the plurality of battery cells 10. The insulation cover 41 holds a plurality of bus bars 60 in a recessed portion, and electrically insulates the adjacent bus bars 60. The bus bars 60 held in the recessed portion are connected to the terminals 11.

The electrical connecting part housing case 40 houses a voltage detection wire 20 which detects the voltage of the battery cell 10, and a temperature detection wire 30 which detects the temperature of the battery cell 10. The voltage detection wire 20 and the temperature detection wire 30 are bundled and placed in a wire housing space groove 80 provided to the insulation cover 41, and connected to a connector 21 through a tube 22. Information of the voltage and information of the temperature are sent from the connector 21 to the outside of the battery module 100.

The insulation cover 41 has an opening above a gas exhaust valve 15 of the plurality of battery cells 10 arranged in a single direction, and forms, with partition walls, a gas exhaust groove 44 which is in communication with the plurality of battery cells 10 in the laminating direction (X-axis direction). With the gas exhaust groove 44, for example, the lower end thereof is opened to face the gas exhaust valve 15 of the plurality of battery cells 10, includes a partition wall on either side of the gas exhaust valve 15 in the longitudinal direction of the top face 10a of the battery cells 10, or in the transverse direction (Y-axis direction) of the battery block 50.

The battery cell 10 is, for instance, a lithium ion secondary battery, and a flat square secondary battery having broad-side faces and narrow-side faces may be used as the battery cell 10. The battery cells 10 are laminated in the thickness direction by causing the broad faces to face each other, and form a substantially rectangular parallelepiped battery block 50. In the ensuing explanation, the respective components of the battery module 100 may be explained by using a rectangular coordinate system with the longitudinal direction of the battery block 50, or the laminating direction of the battery cells 10, as the X-axis direction, the transverse direction of the battery block 50 as the Y-axis direction, and the height direction of the battery block 50 as the Z-axis direction.

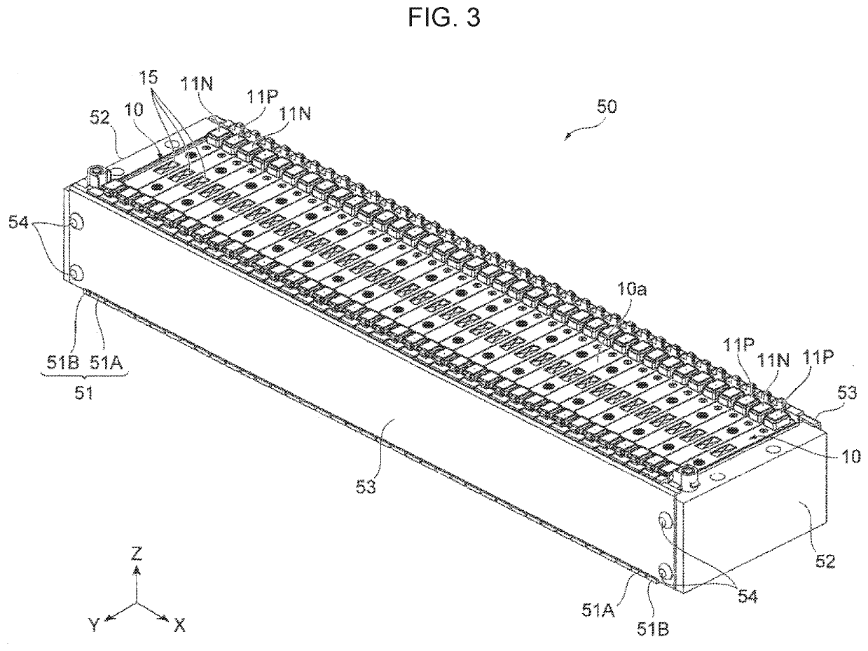

FIG. 3 is an external perspective view of the battery block 50 shown in FIG. 2.

The battery block 50 comprises a plurality of battery cells 10, a cell holder 51 for holding each of the battery cells 10, a pair of end plates 52 disposed on either end of the laminating direction of the plurality of battery cells 10, and a pair of side plates 53 disposed on either side of the pair of end plates 52.

The cell holder 51 is prepared, for example, from a resin material having insultation properties such as engineering plastic. The cell holder 51 is classified into a plurality of intermediate cell holders 51A disposed between the battery cells 10, and a pair of end cell holders 51B disposed on either end of the plurality of battery cells 10 laminated via the plurality of intermediate cell holders 51A. The cell holder 51 is disposed alternately with the battery cell in the laminating direction (X-axis direction) of the plurality of battery cells 10, and the plurality of battery cells 10 are laminated in the thickness direction by sandwiching the individual battery cells 10 from either side in the thickness direction (X-axis direction). The intermediate cell holder 51A also plays the role as a spacer which creates a space between two battery cells 10 which are adjacent in the laminating direction.

The battery cell 51 laminated together with the cell holder 51 is sandwiched by the pair of end plates 52 from either end in the laminating direction. The pair of end plates 52 is, for example, a metal member, or reinforced plastic, formed in a rectangular flat plate shape corresponding to the shape of the broad-side faces 12a of the battery container 12 configuring the battery cell 10.

The battery cell 51 laminated together with the cell holder 51 is sandwiched by the pair of side plates 52 from the side of the narrow-side faces 12b. A through hole through which a fastening member 54, such as a bolt, is to be inserted is provided to either end of the side plate 52 in the longitudinal direction, and the side plate 53 and the end plate 52 are connected by the fastening member 54, such as a bolt, through the through hole. Moreover, one end of the side plate 52 in the transverse direction is bent at a right angle in an L-shape, and the bent part is fitted with a groove part formed on the cell holder. Furthermore, by inserting the fastening member 54, such as a bolt, through the through hole on either end in the longitudinal direction and fastening the fastening member 54 to the screw hole of the end plate 52, the fastening member 54 is coupled to the pair of end plates 52.

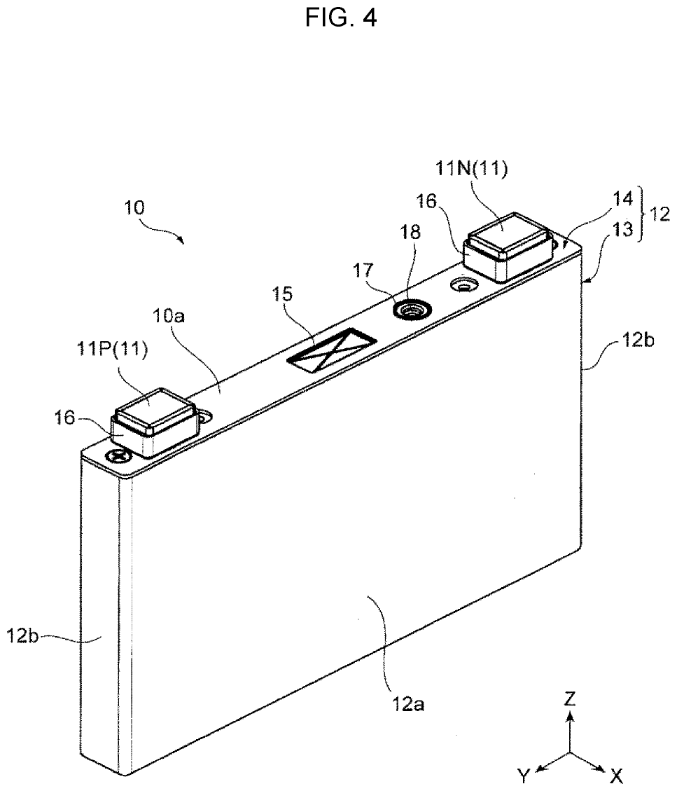

FIG. 4 is an external perspective view of the battery cell 10 shown in FIG. 3.

The battery cell 10 is, for example, a flat square lithium ion secondary battery, and includes a rectangular top face 10a, a pair of external terminals 11 disposed by being separated from the top face 10a in the longitudinal direction (Y-axis direction), and a gas exhaust valve 15 provided between the pair of external terminals 11. The battery cell 10 comprises, for example, a metal battery container 12 prepared from aluminum or an aluminum alloy. The battery container 12 is of a flat rectangular parallelepiped shape, and has broad-side faces 12a having a large area on either side in the thickness direction (X-axis direction), and narrow-side faces 12b having a small area on either side in the width direction (Y-axis direction).

The battery container 12 is configured, for example, from a bottomed square cylindrical battery can 13 in which the upper part thereof is opened, and a rectangular plate-shaped battery lid 14 for sealing the opening of the battery can 13. The battery lid 14 is connected to the opening of the battery can 13, for example, via laser welding. The inside of the battery container 12 houses, for example, a wound electrode group in which an electrode and a separator have been laminated and wound, a current collector which connects the electrodes of the wound electrode group and the pair of external terminals 11, an insulation sheet which insulates the space between the wound electrode group and the battery container, and an electrolyte in which the wound electrode group is impregnated.

Of the pair of external terminals 11, one is a positive electrode external terminal 11P, and the other is a negative electrode external terminal 11N. The pair of external terminals 11 is disposed separately at one end and the other end of the rectangular top face 10a of the battery cell 10; that is, in the longitudinal direction (Y-axis direction) of the rectangular top face 10a of the battery lid 14, and is electrically insulated from the battery container 12 with a resin gasket 16 having insulation properties disposed between the battery lid 14 and the battery container 12.

The gas exhaust valve 15 is provided between the pair of external terminals 11 disposed on the top face 10a of the battery cell 10; that is, the top face 10a of the battery lid 14. The gas exhaust valve 15 is provided, for example, by pressing a center part of the battery lid 14 in the longitudinal direction and forming a thin-walled part formed on the battery lid 14, and forming a slit groove on the thin-walled part. The gas exhaust valve 15 ensures the safety of the battery cell 10, for example, by being opened when gas is generated within the battery container 12 due to an abnormality such as an overcharge of the battery cell 10 and the internal pressure of the battery container 12 increases beyond a predetermined pressure, and discharging the gas within the battery container 12 to the outside.

Moreover, the battery lid 14 includes a liquid injection hole 17 for injecting electrolyte into the battery container 12, and a liquid injection plug 18 for sealing the liquid injection hole 17. For example, by injecting electrolyte into the battery container 12 via the liquid injection hole 17 of the battery lid 14 and thereafter connecting the liquid injection plug 18 to the liquid injection hole 17 via laser welding, the liquid injection hole 17 can be sealed with the liquid injection plug 18.

As shown in FIG. 3, the plurality of battery cells 10 configuring the battery block 50 are disposed such that the broad-side faces 12a of the battery container 12 are laminated in a manner of facing each other, and the gas exhaust valve 15 provided to the top face 10a of the battery cell 10, and the external terminal 11, are arranged in a single direction (X-axis direction) of the battery block 50. More specifically, as a result of the gas exhaust valve 15 being provided at the center of the rectangular top face 10a of the battery cell 10 in the longitudinal direction (Y-axis direction), the gas exhaust valves 15 of the plurality of battery cells 10 are arranged in a line in the laminating direction (X-axis direction) of the plurality of battery cells 10; that is, the transverse direction (X-axis direction) of the rectangular top face 10a of the battery cell 10, or the thickness direction (X-axis direction) of the battery cell 10. Because the gas exhaust valves will be unified in a single direction by being arranged in the manner described above, the sites where gas is generated can be managed easily, and a duct may also be provided. Moreover, because the external terminals will be unified in a single direction, there is also an advantage in that the wires can be designed more easily.

Moreover, the plurality of battery cells 10 configuring the battery block 50 are laminated by being alternately inverted 180° so that, of the two battery cells 10 that are adjacent in the laminating direction, the positive electrode external terminal 11P of one battery cell 10 and the negative electrode external terminal 11N of the other battery cell 10 become adjacent in the laminating direction. The positive electrode external terminal 11P and the negative electrode external terminal 11N adjacent in the laminating direction of the plurality of battery cells 10 are connected via the bus bar 60 shown in FIG. 2. That is, the plurality of battery cells 10 are connected in series by a plurality of bus bars 60 which connect the positive electrode external terminal 11P and the negative electrode external terminal 11N adjacent in the laminating direction. The bus bars 60 are connected, for example, to the top face of the external terminal 11 of the battery cell 10 via laser welding.

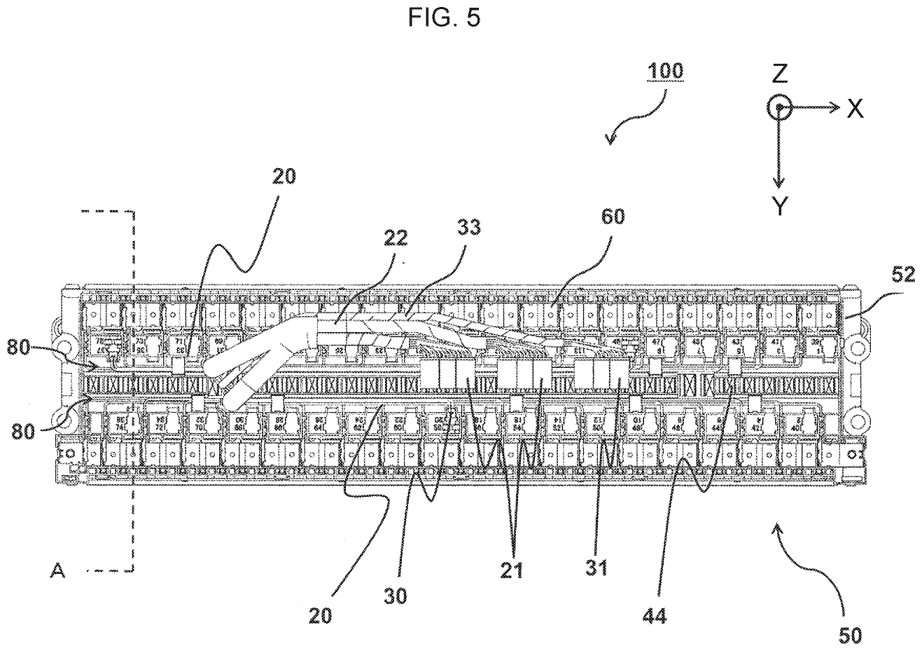

FIG. 5 is a plan view showing a state where the top cover 42 of the battery module 100 shown in FIG. 1 has been removed.

The battery module 100 of this embodiment comprises, as described above, a plurality of battery cells 10, a plurality of voltage detection wires 20 connected to an external terminal 11 of each of the battery cells 10, and a plurality of temperature detection wires 30 connected to the battery cells 10. A gas exhaust groove 44, which is communication in the laminating direction (X-axis direction), is formed at the center part in the longitudinal direction of the top face 10a of the battery cell 10; that is, in the transverse direction (Y-axis direction) of the battery block 50, and a wire housing space groove 80 is provided in parallel adjacent to either side for housing the voltage detection wires 20 and the temperature detection wires 30.

The wire housing space grooves 80 become an electrical connecting member housing case capable of housing wires such as voltage detection wires and temperature detection wires.

With the voltage detection wire 20, one end is connected to the external terminal 11 of the individual battery cells 10 via the bus bar 60, and the other end is connected to the connector 21. The connector 21 is connected, for example, to a battery control unit (BCU). The BCU detects the voltage of the individual battery cells 10 via the plurality of voltage detection wires 20 connected to the external terminal 11 of the individual battery cells 10. The plurality of voltage detection wires 20 are bundled, for instance, at the inner side of the opening 43 of the top cover 42, and placed through a tube 22. The tube 22 which covers the bundled plurality of voltage detection wires 20 extends, for example, from the inner side of the opening 43 of the top cover 42 to the connector 21 on the outer side of the cover 40.

The temperature detection wire is connected to the plurality of battery cells 10 via a thermistor. In this embodiment, six temperature detection wires 30, in which two wires form a pair, are connected to the top face 10a of three battery cells 10. With the temperature detection wire 30, one end is connected to the thermistor, and the other end is connected to the connector 31. The thermistor connected to one end of the temperature detection wire 30 contacts the top face 10a of the battery cell 10, in a manner of being pressed against thereto, by a pressing member provided to one end of the temperature detection wire 30.

The connector 31 of the temperature detection wire 30 is also connected, for instance, to a BCU (battery control unit) in the same manner as the connector 21 of the voltage detection wire 20. The BCU detects the temperature of the individual battery cells 10 in contact with the thermistor by detecting the voltage of the individual thermistors in contact with the top face 10a of the battery cell 10 with the temperature detection wires 30, in which two wires form a pair, connected to the individual thermistors. The number of thermistors may be any number as required, and two, four or more thermistors may be provided to the battery module 100.

The plurality of temperature detection wires 30 are bundled in the same manner as the voltage detection wires 20, for instance, at the inner side of the opening 43 of the top cover 42, and placed through a tube 33. The tube 33 which covers the bundled plurality of temperature detection wires 30 extends, in the same manner as the tube 22 covering the bundled plurality of voltage detection wires 20, for instance, from the inner side of the opening 43 of the top cover 42 to the connector 31 on the outer side of the cover 40.

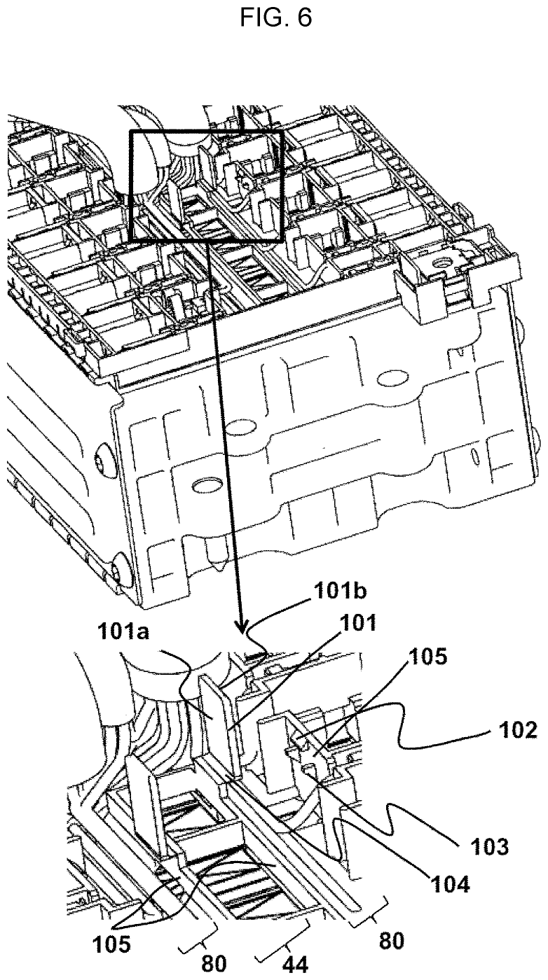

FIG. 6 is an exploded perspective view of the electrical connecting member housing case of the battery module 100 shown in FIG. 5, and is a diagram showing a state where the lid part of the wire housing space groove 80 has been opened.

A wire housing space groove 80 is formed on the connecting member housing case with a bottom part and a wall part 105. The wall part 105 encompasses the wires, and a part thereof becomes a partition of the gas exhaust groove 44 and the wire housing space. The wall part 105 includes an inner wall facing the wires, and an outer wall, an end face, and a lid part which form the outer faces of the electrical connecting member housing case. The outer wall is facing a discharge groove 44. Connected to the lid part 101 is an inner wall 105a or an end face 105b of the wall part 105 via a hinge part 104. FIG. 6 shows a state where the lid part 101 is opened upward, via the hinge 104, from the inner wall of the wire housing space groove 80 of the wall part which partitions the wire housing space groove 80 housing the voltage detection wire 20 and the temperature detection wire 30, and the gas exhaust groove 44.

The lid part 101 has broad faces 101a and narrow faces 101b, and one of the narrow faces 101b or a part of the broad faces 101a is connected to the hinge part 104.

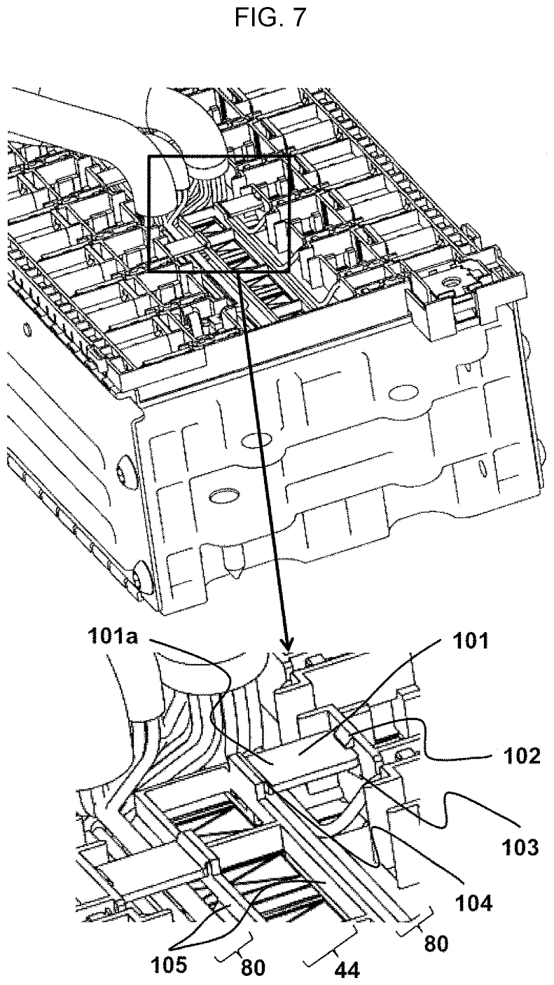

FIG. 7 is a diagram showing a state where the lid 101 in FIG. 6 has been closed.

In FIG. 7, the lid 101 opened upward in FIG. 6 opens the wire housing space grooves 80 housing the voltage detection wires 20 and the temperature detection wires 30 in a manner of facing the inner wall which is bent from the hinge part 104 to become a horizontal direction and which faces the narrow faces 101b on the counter-hinge side. The facing walls on the counter-hinge side may be provided with a stopping means for inhibiting the opening of the lid part 101, such as the locking protrusion 102, and the lid part 101 is locked by going over the locking protrusion 102.

Moreover, a stopper 103 may be provided between the locking protrusion 102 of the wall part 105 and the bottom part 106 so that the wires are not damaged and excessive stress is not applied to the hinge part 104 as a result of the lid part 101 being bent downward below the protrusion 102 beyond a horizontal position.

Here, the lid 101 may be closed after housing the voltage detection wires 20 and the temperature detection wires 30 in the wire housing space groove 80, or the lid part 101 may be locked with the locking protrusion 102 in advance before housing the voltage detection wires 20 and the temperature detection wires 30, and the voltage detection wires 20 and the temperature detection wires 30 may be housed by bending the lid part 101 downward from the horizontal direction. However, in the foregoing case, the stopper 103 is not provided.

Because a gas exhaust valve is provided to the top face 10a of each of the battery cells 10, the gas exhaust groove 44 is provided along the laminating direction (X-axis direction) of the battery cells 10. The wire housing space grooves 80 are provided along the gas exhaust groove 44 on either side of the gas exhaust groove 44. A plurality of voltage detection wires 20 are laid on one wire housing space groove 80, and a temperature detection wire 30 is laid on the other wire housing space groove 80.

More specifically, the wire housing space groove 80 can be configured from a plurality of second supporting parts 81 provided adjacent to the gas exhaust valve 15 in the transverse direction (Y-axis direction) of the battery block 50; that is, in the longitudinal direction of the top face 10a of the battery cells 10.

The operation of the battery module 100 of this embodiment is now explained.

The battery module 100 of this embodiment is mounted, for example, on a hybrid vehicle or a plug-in hybrid vehicle which runs by using both an engine and a motor, or on an electrically driven vehicle such as an electric vehicle which runs by using only a motor. The battery module 100 supplies the electric energy accumulated in the plurality of battery cells 10, for example, to an external device such as a motor, and accumulates the electric energy supplied, for example, from an external device such as a generator in the plurality of battery cells 10, via the external connection terminal 61 shown in FIG. 1 and FIG. 2.

Accordingly, with the battery module 100 comprising a plurality of battery cells 10 and which is mainly used by being mounted on vehicles, even more battery cells 10 are being used pursuant to the cost reduction and miniaturization of the battery cells 10. When the number of battery cells 10 used in the battery module 100 increases, efficient wiring and a slimmer electrical connecting member housing case are required to deal with the increase in the number of voltage detection wires 20 and temperature detection wires 30 to be connected to the battery cells 10. Thus, for example, with the wire housing frame described in PTL 1, because a hinge is provided to the housing outer side wall (corresponds to the outer wall 105c) of the side wall forming the housing frame, space for forming the lid via the hinge is required. Accordingly, when providing two rows of the wire housing space groove as shown in FIG. 5, a gap is required between the two wire housing space grooves for forming the lid to cover the respective housing frames, and, consequently, the wires cannot be efficiently arranged as a pair of parallel lines, and there is a possibility that the miniaturization of the battery module may become difficult. Moreover, when providing another member, such as a duct, adjacent to the wire housing space groove, because it is necessary to secure space at least for the hinge, there is a possibility that the size of the battery module will become enlarged by that much.

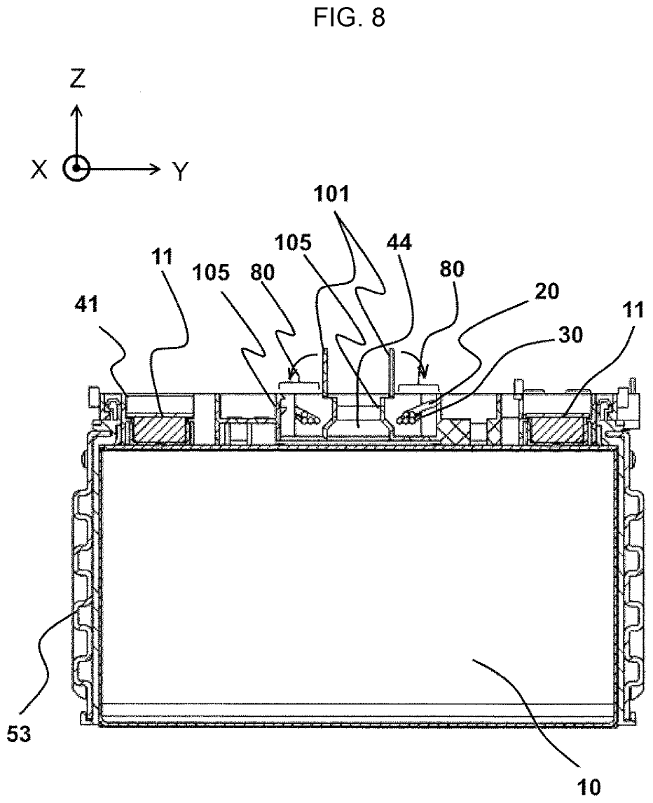

FIG. 8 is a cross sectional view of the A-cross section of FIG. 5.

An insulation cover 41 is provided to the top face 10a of the battery cell 10, and a side plate 53 is provided to the side face. Holes into which the positive electrode external terminal 11P and the negative electrode external terminal 11N are to be respectively inserted are provided on either end of the insulation cover 41 in the transverse direction (Y direction). Two rows of the wire housing space groove 80 are provided between the respective holes into which the positive electrode external terminal 11P and the negative electrode external terminal 11N are to be inserted along the longitudinal direction of the insulation cover 41. A gas exhaust groove 44 is provided between the two rows of the wire housing space groove 80. The two rows of the wire housing space groove may separately house the temperature detection wires and the voltage detection wires, and they may be separately housed in the respective grooves.

The wall part 105 on the side of the gas exhaust groove 44 of the wire housing space groove 80 is a wall that forms the gas exhaust groove 44, and a lid part 101 is provided to the wall part 105 via a hinge part 104. The lid part 101 moves in the direction of the arrows shown in FIG. 8, and the wire housing space is closed with the lid part 101.

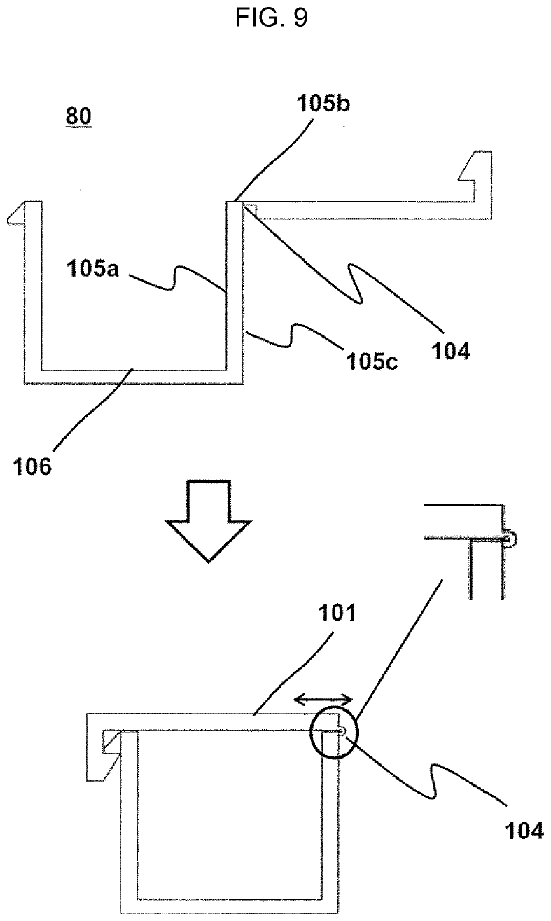

FIG. 9 is a simplified diagram of the part of the wire housing space groove in the conventional technology.

The wire housing space groove 80 is a part of the insulation cover, and, for example, is integrally formed with the lid part 101 via resin injection molding. Because the hinge part 104 is formed on the outer wall 105c of the wall, it is necessary to provide space for the lid part and the hinge part, and this is a significant restraint in terms of design. Even when manufacturing the insulation cover 41, it is necessary to provide space at the outer side of the wall (on the side of the outer wall 105c) as the injection mold for forming the lid part 101 and the hinge part 104 will be positioned above and below the insulation cover.

Moreover, because the hinge part 104 will be bent 180° upon closing the lid, the stress applied to the hinge part 104 will also be significant, and the tolerable range of the dimension setting and selection of applicable resin will also be limited. As the bent part of the hinge part 104 will protrude from the outer face of the wall of the wire housing space groove 80 after the lid is closed, this may become a restraint in terms of design or become the cause of hooking. Moreover, the strength of one side of the lid must be secured with a thin and soft hinge part 104 for protection against vibration or shock in a direction that is perpendicular to the hinge part 104 of the lid (vibration in the direction shown with the arrow of FIG. 9).

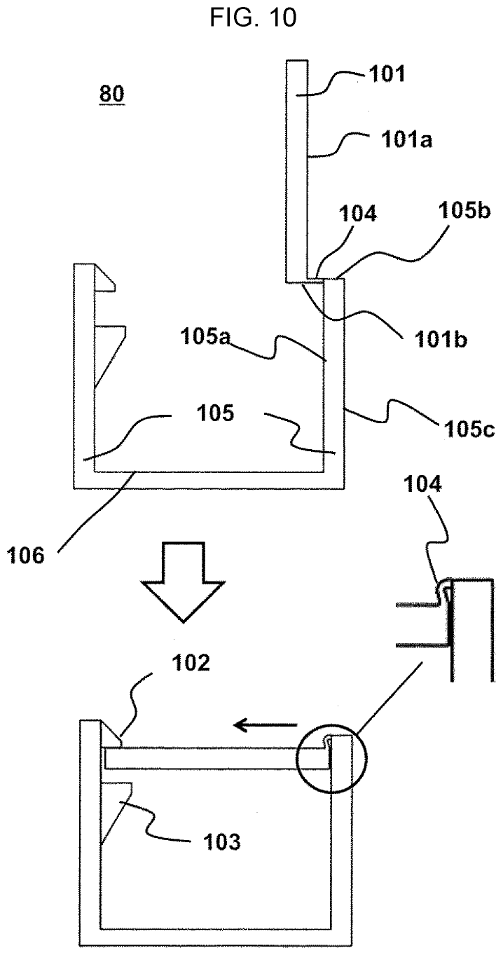

FIG. 10 is a simplified diagram in which a part of the wire housing space groove 80 of first embodiment has been extracted.

The wire housing space groove 80 is a part of the insulation cover 41, and, for example, is integrally formed with the lid part 101 via resin injection molding. The wire housing space groove 80 includes a bottom part 106 which is integrally formed with the side of the insulation cover 41, a wall part 105, and a lid part 101 which is connected to the wall part 105.

Wires such as the voltage detection wires 20 and the temperature detection wires 30 are housed in the wire housing space formed with the bottom part 106 and the wall part 105. The wall part 105 includes an inner wall 105a as a wall on the inner side facing the wires, an end face 105b formed on the end of the wall, and an outer wall 105c as a face on the outer side. The hinge part 104 is provided to the inner wall 105a, and connects the wall part 105 and the lid part 101. Because the hinge part 104 is provided to the inner wall 105a, which is the inner side of the wall part 105, there is no influence on the outer side of the wires of the wall, and can be designed without any restraint. Thus, as shown in FIG. 5, the bus bar, the wire housing space grooves 80, and the gas exhaust groove 44 can be efficiently arranged in the insulation cover 41. The insulation cover 41 is provided with a recess for holding the bus bars 60 on either end in the transverse direction (Y direction). The adjacent bus bars 60 are electrically insulated from each other. The wire housing space grooves 80 are respectively provided in parallel to the inner side of the recess, and a gas exhaust groove 44 is disposed between the two rows of the wire housing space groove 80. Because the bent part of the hinge part 104 will not protrude from the outer face of the wall of the wire housing space groove 80 after the lid part 101 is closed, the design can be created without having to consider the foregoing protrusion of the hinge part 104 (other members can be placed adjacent to the outer wall 105c), an efficient design can be realized.

The degree of freedom of design around the outer side of the wire housing space will improve, and a wire housing space can be additionally provided adjacently, and a plurality of temperature detection wires can be laid along a single direction in which the gas exhaust valves are aligned. Thus, according to the present invention, it is possible to provide a battery module capable of dealing with the increase in the voltage detection wires and temperature detection wires associated with the increase in the number of battery cells, and realizing the miniaturization thereof.

The inner wall 105a facing the inner wall, which is provided with the hinge part 104, is provided with a locking protrusion 102 provided on the side of the end face 105b of the wall part 105, and a stopper 103 provided to the side of the bottom part 106 of the wall part 105. In a state where the lid part 101 is closed, the locking protrusion 102 is facing the face on the outer side of the broad face 101a of the lid part 101, and the stopper 103 is facing the face on the inner side of the broad face 101a. The locking protrusion 102 prevents the lid part 101 from opening, and the stopper 103 prevents the lid part 101 from moving toward the deep end of the space.

The lid part 101 has a a pair of broad faces 101a and a pair of narrow faces 101b, and the hinge is connected to the broad face 101a on the outer side of the space. Accordingly, because the lid part 101 will face upward in a state where the lid part 101 is open, there is no influence on the other members in a state where the lid is open.

Moreover, with the lid part 101, because the narrow faces 101b are facing the inner wall 105a in a state where the wire housing space 80 is closed, the lid part 101 can obtain a reaction from the inner wall 105a (force in the direction of the arrow shown in FIG. 10), and, because both narrow faces 101b will be sandwiched with either wall face, the lid part 101 will have a strong structure against vibration in a direction that is horizontal to the insulation cover.

Moreover, as the lid part 101 will be pressed against the locking side wall part due to the reactive force of the hinge part 104, the lid part 101 will be more reliably locked with the locking protrusion 102, and the degree of freedom of the gap between either narrow face and either wall face of the lid part 101 will also increase.

As described above, according to the battery module 100 of this embodiment, it is possible to deal with the increase in the voltage detection wires 20 and the temperature detection wires 30 associated with the increase in the number of battery cells 10 and realize the miniaturization of the battery module 100, as well as more firmly and reliably close the wires.

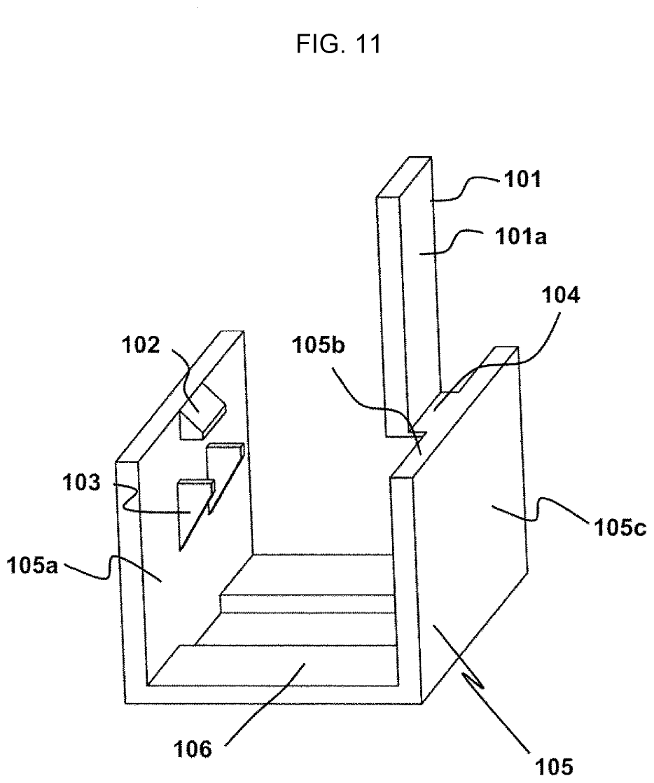

FIG. 11 is a perspective view in a state where the lid part of FIG. 10 has been opened.

### Second Embodiment

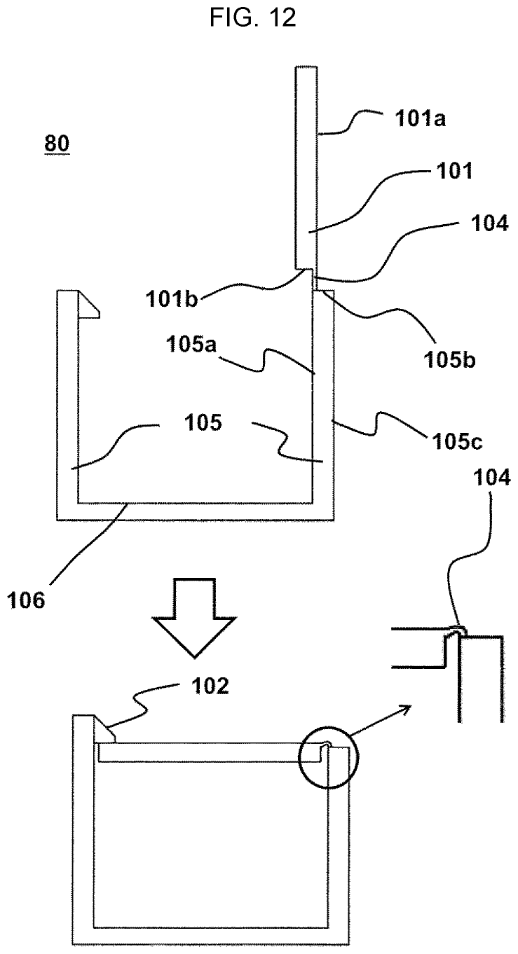

FIG. 12 is a simplified diagram of the wire housing space groove 80 of the second embodiment. As with the first embodiment, the wire housing space groove 80 is a part of the insulation cover, and is integrally formed with the lid part 101 via resin injection molding.

In the second embodiment, the hinge part 104 of the first embodiment connects the end face 105b of the wall part 105 and the narrow face 101b of the lid part 101. Note that, because the remaining structure of the battery module 100 of the first embodiment and the second embodiment is the same, the explanation thereof is omitted.

In a state where the lid part 101 is open, the lid part 101 is erected upward (perpendicular direction) relative to the bottom part 106. While the hinge 104 may be provided anywhere on the end face 105b, preferably, the hinge 104 is provided to the inner wall side 105a of the end face 105b along the inner wall 105a (as an extension of the inner wall) in a state where the lid part 101 is open. As a result of providing the hinge part in the foregoing manner, there are advantages in that the shape of the mold can be simplified (because when there is a recess in the inner face of the wall, it may be necessary to use a slide-type mold), and the hinge part can be shortened.

According to the battery module 100 of the second embodiment, in addition to yielding the same effects as the battery module 100 of the first embodiment, there are the following advantages. The thickness of the hinge part 104 needs to be reduced in comparison to its periphery to facilitate the bending thereof, and an appropriate thickness is roughly 0.05 to 0.3 mm. Thus, it may become difficult for the resin to flow in the injection molding, and in particular the resin flow direction in the hinge part 104 in Embodiment 1 will become perpendicular, which will obstruct the force of the resin flow and inhibit the propagation of the resin pressure. However, according to this embodiment, because the force of the hinge part 104 is not blocked along the resin flow and the resin pressure can be easily propagated, resin can be easily filled in the lid part.

With the lid part 101, because the narrow face 101b is facing the inner wall 105a in a state where the wire housing space 80 is closed, the lid part 101 can obtain a reaction from the inner wall 105a, and, because both narrow faces 101b will be sandwiched with either wall face, the lid part 101 will have a strong structure against vibration in a direction that is horizontal to the insulation cover.

### Third Embodiment

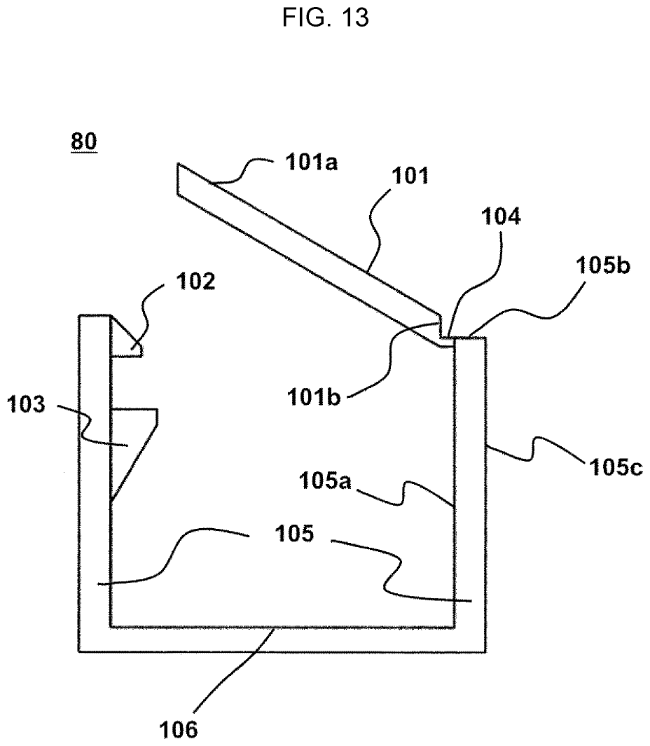

FIG. 13 is a simplified diagram of the wire housing space groove 80 of the third embodiment. As with the first embodiment, the wire housing space groove 80 is a part of the insulation cover, and is integrally formed with the lid part 101 via resin injection molding.

In the third embodiment, the hinge part 104 of the first embodiment connects the inner wall 105a of the wall part 105 and the narrow face 101b of the lid part 101. Note that, because the remaining structure of the battery module 100 of the first embodiment and the second embodiment is the same, the explanation thereof is omitted. The lid part 101 has a structure of facing diagonally upward, in an open state, relative to the bottom part 106. As a result of adopting this kind of structure, because the bend of the hinge part 104 can be reduced by that much upon closing the wire housing space groove 80, the stress of the hinge part 104 can be alleviated. Moreover, because the wall thickness of the hinge part 104 can also be increased, the resin flow during molding can be improved, and the options of applicable resin can also be increased.

Moreover, with the lid part 101, because the narrow face 101b is facing the inner wall 105a in a state where the wire housing space 80 is closed, the lid part 101 can obtain a reaction from the inner wall 105a, and, because both narrow faces 101b will be sandwiched with either wall face, the lid part 101 will have a strong structure against vibration in a direction that is horizontal to the insulation cover.

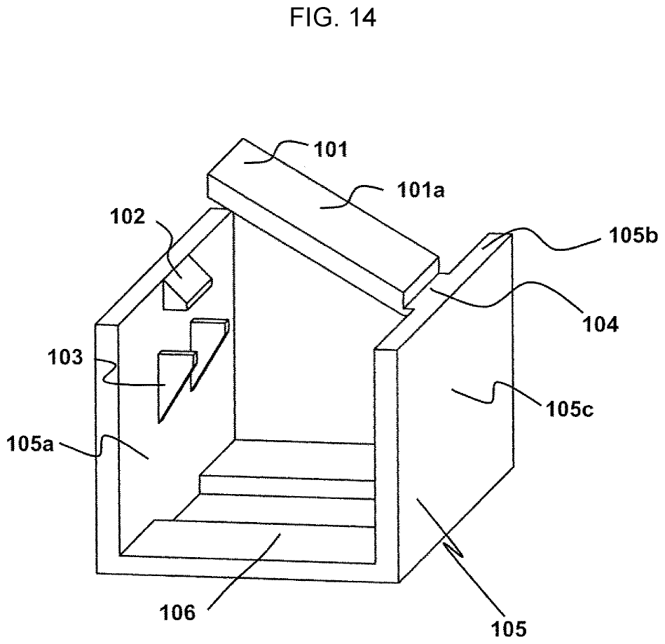

FIG. 14 is a perspective view in a state where the lid of FIG. 13 has been opened.

### Fourth Embodiment

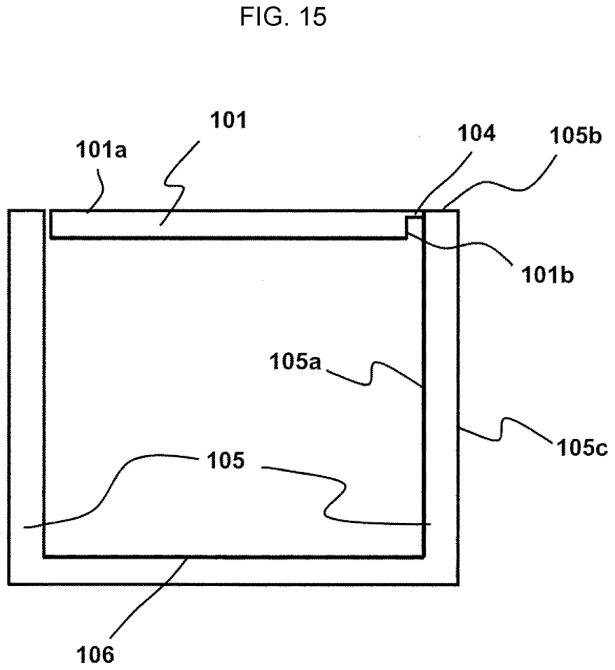

FIG. 15 is a simplified diagram of the wire housing space groove 80 of the fourth embodiment. As with the first embodiment, the wire housing space groove 80 is a part of the insulation cover, and is integrally formed with the lid part 101 via resin injection molding.

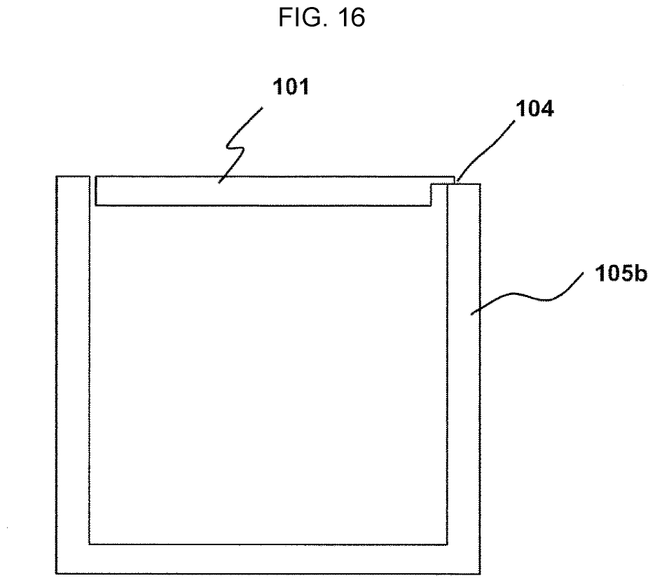

In the fourth embodiment, the hinge part 104 in the first embodiment is connected to the inner wall 105a of the wall part 105 and the narrow faces 101b of the lid part 101. Otherwise, as shown in FIG. 16, the end 105b of the wall part 105 and the narrow faces 101b of the lid part 101 may also be connected. Because the remaining structure is the same as the remaining structure of the battery module 100 of the first embodiment and the second embodiment, the explanation thereof is omitted.

The lid part 101 is in a horizontal state relative to the bottom part 106 in an open state and in a closed state. By setting the lid part 101 to be horizontal, the mold shape can be further simplified. Moreover, because stress is not applied to the hinge 104 in a closed state, there is an advantage in that the resistance against deterioration is strong. Moreover, because a locking protrusion 102 is not particularly required, the structure can be simplified. Upon housing the voltage detection wires 20 and the temperature detection wires 30 in the wire housing space grooves 80, for instance, the lid part 101 is housed by being pressed downward from a horizontal position. In the foregoing case, the stopper 103 is not provided.

Moreover, because the narrow faces 101b are facing the inner wall 105a in a state where the lid part 101 has closed the wire housing space 80, the lid part 101 can obtain a reaction from the inner wall 105a, and, because both narrow faces 101b are sandwiched by either wall face, the lid part 101 will have a strong structure against vibration in a direction that is horizontal to the insulation cover.

While the embodiments of the present invention have been explained in detail with reference to the appended drawings, the specific configuration is not limited to these embodiments, and any design change or the like within a range that does not deviate from the subject matter of the present invention shall be covered by the present invention.

### REFERENCE SIGNS LIST

10 battery cell
10a top face
11 external terminal
11N negative electrode external terminal
11P positive electrode external terminal
12 battery container
12a broad-side face
12b narrow-side face
15 gas exhaust valve
16 gasket
17 liquid injection hole
18 liquid injection plug
20 voltage detection wire
21 connector (voltage detection wire)
22 tube (voltage detection wire)
30 temperature detection wire
31 connector (temperature detection wire)
33 tube (temperature detection wire)
40 electrical connecting part housing case
41 insulation cover
42 top cover
44 gas exhaust groove
45 harness cover
50 battery block
51 cell holder
51A intermediate cell holder
51B end cell holder
52 end plate
53 side plate
60 bus bar
61 external connection terminal
80 wire housing space groove
100 battery module
101 lid part
101a broad faces
101b narrow faces
102 locking protrusion
103 stopper
104 hinge part
105 wall part
105a inner wall
105b end face
105c outer wall
106 bottom part

1. An electrical connecting member housing case including a wire housing space formed from a bottom part, a wall part, and a lid part, wherewith the wall part includes an outer wall, an end face, and an inner wall facing the wires, wherein
the lid part is connected to the wall part via a hinge part provided to the inner wall or the end face.

2. The electrical connecting member housing case according to claim 1, wherein
the lid part includes a pair of broad faces and a pair of narrow faces, and the narrow faces face the inner wall in a state where the wire housing space is closed with the lid part.

3. The electrical connecting member housing case according to claim 2, Wherein
the wall part includes a locking protrusion which inhibits the lid part from opening.

4. The electrical connecting member housing case according to claim 3, wherein
the hinge part connects the inner wall and the broad faces.

5. The electrical connecting member housing case according to claim 3, wherein
the hinge part connects the inner wall and the narrow faces.

6. The electrical connecting member housing case according to claim 3, wherein
the hinge part connects the end face and the narrow faces.

7. The electrical connecting member housing case according to claim 4, wherein
the broad faces of the lid part are provided perpendicular to the bottom part in a state where the wire housing space is open.

8. The electrical connecting member housing case according to claim 5, wherein
the broad faces of the lid part provided parallel to the bottom part in a state where the wire housing space is open.

9. The electrical connecting member housing case according to claim 5, wherein
the broad faces of the lid part provided diagonal to the bottom part in a state where the wire housing space is open.

10. The electrical connecting member housing case according to claim 7, wherein
the inner wall is provided with a stopper between the locking protrusion and the bottom part.

11. A battery module includes:
a laminated body configured by laminating a plurality of batteries including a positive electrode terminal and a negative electrode terminal; and
the electrical connecting member housing case according to claim 1 provided to the positive electrode terminal and the negative electrode terminal of the laminated body, wherein
the electrical connecting member housing case includes:
a bus bar housing space for housing bus bars which electrically connect the plurality of batteries; and
wires provided to the bus bars, wherein
the wires are housed in the wire housing space.

12. The battery module according to claim 11, wherein
the bus bar housing space is positioned to face the outer wall.
